(19) United States
(12) Patent Application Publication
(10) Pub. No.: US 2019/0006962 A1
(43) Pub. Date: Jan. 3, 2019

(54) MULTI-MODAL SWITCH ARRAY

(71) Applicant: INTERLINK ELECTRONICS, INC., Westlake Village, CA (US)

(72) Inventors: Chee Wai LU, Singapore (SG); Cheng Seong LEE, Singapore (SG); Hock Cheng NG, Singapore (SG); Wai Jye CHAN, Singapore (SG)

(73) Assignee: INTERLINK ELECTRONICS, INC., Westlake Village, CA (US)

(21) Appl. No.: 16/067,559

(22) PCT Filed: Jan. 5, 2017
(86) PCT No.: PCT/US2017/012378

§ 371 Date: Jun. 29, 2018

Related U.S. Application Data
(60) Provisional application No. 62/274,890, filed on Jan. 5, 2016.

(51) Int. Cl. H02N 2/18; G08B 6/00

(52) U.S. Cl. CPC H02N 2/18; G08B 6/00

(57) ABSTRACT

A system includes a first force sensing transducer being configured to enable force sensing detection of a first force input on a first contact interface, a memory, and a processor that is operatively coupled to the memory and the first force sensing transducer. The processor is configured to perform operations including detect the first force input on the first contact interface via the first force sensing transducer, measure at least one of a magnitude or a direction of the first force input detected by the first force sensing transducer, compute a force sensing data parameter based on the measured at least one of the magnitude or the direction of the first force input; determine an output function based on the force sensing data parameter; and cause an activation of the output function.

### FIELD

The embodiments discussed herein are related to a multi-modal switch array.

### BACKGROUND

Conventional vehicle interfaces often use either mechanical switches or capacitive based touch sensors. Mechanical switches often physically protrude from a surface and may have reliability issues as the mechanical switches are used over time. Capacitive based touch sensors typically are often incompatible with glove operation and often do not offer rejection of an unintentional touch.

The subject matter claimed herein is not limited to embodiments that solve any disadvantages or that operate only in environments such as those described above. Rather, this background is only provided to illustrate one example technology area where at least one embodiment described herein may be practiced.

### BRIEF DESCRIPTION OF THE DRAWINGS

Example embodiments will be described and explained with additional specificity and detail through the use of the accompanying drawings in which:

FIG. 1 illustrates an arrangement of an example multi-modal switch;

FIG. 2 illustrates a physical stack of a multi-modal switch;

FIG. 3 illustrates an example method for dynamic force detection and measurement, computational processing of dynamic force detection and measurement and interactive functional control of a vehicle by operation of a multi-modal switch;

FIG. 4 illustrates a flow diagram of another example method of dynamic force detection and measurement, computational processing of dynamic force detection and measurement, and interactive functional control of a vehicle by operation of a multi-modal switch;

FIGS. 5A-5B illustrates example embodiments where two or more pairs of differential-mode force sensing elements may be implemented;

FIG. 6 illustrates another embodiment of a physical stack of a multi-modal switch; and

FIG. 7 illustrates a block diagram of an example computer system to select filter patterns, all according to at least one embodiment of the present disclosure.

### DESCRIPTION OF EMBODIMENTS

Conventional vehicle interfaces often use either mechanical switches or capacitive-based touch sensors. Mechanical switches may often physically protrude from a surface and may have reliability issues as the mechanical switches are used over time. Another limitation to conventional mechanical switches used in vehicle interfaces may is that they may require mechanical calibration of pre-load in a switch interface assembly. Further, a triggering level of a conventional mechanical switch may not be electronically programmable. Conventional capacitive-based touch sensors may also have numerous drawbacks, such as often being incompatible with glove operation, not offering a feature for rejection of an unintentional touch or an unintentional triggering due to an external forces, such as an exposure to rain or water. And, both conventional mechanical switches and conventional capacitive-based touch sensors may include functionality that may be limited to discrete triggering level (e.g., “on” or “off” or 2-level toggling).

Aspects of the present disclosure address these and other shortcomings by providing a multi-modal switch. The multi-modal switch may include one or more force sensing elements and, in some embodiments, may include one or more haptic feedback elements for use in conjunction with a user interface (e.g., a vehicle user interface). The one or more force sensing elements may be configured to detect one or more physical input modalities including but not limited to: an intentional touch, a grip, or a gesture on a respective external surface of the user interface. The multi-modal switch may output haptic feedback that corresponds to the received one or more physical input modalities. The external surface of the user interface may be implemented using a switch with little or no movement (e.g., a “zero-travel” switch) or a movable switch with haptic feedback. These physical input and output modalities of the multi-modal switch may be used for various functions including but not limited to user control of access, entry, entertainment, infotainment, instrumentation, lighting, and/or ventilation.

In at least some embodiments, a multi-modal switch may include one or more force sensing elements which may provide dynamic force detection and measurement. A system that includes or is connected to the multi-modal switch may perform computational processing of dynamic force detection and measurement data from each force sensing element to one or more determine discrete touch points, one or more multi-touch points, and/or one or more gestures. The multi-modal switch may include physical stack-up topology that includes an external surface, an interposer with protrusions, one or more force sensing elements, one or more haptic feedback elements and a housing. Embodiments of the present disclosure are further described with reference to the accompanying drawings.

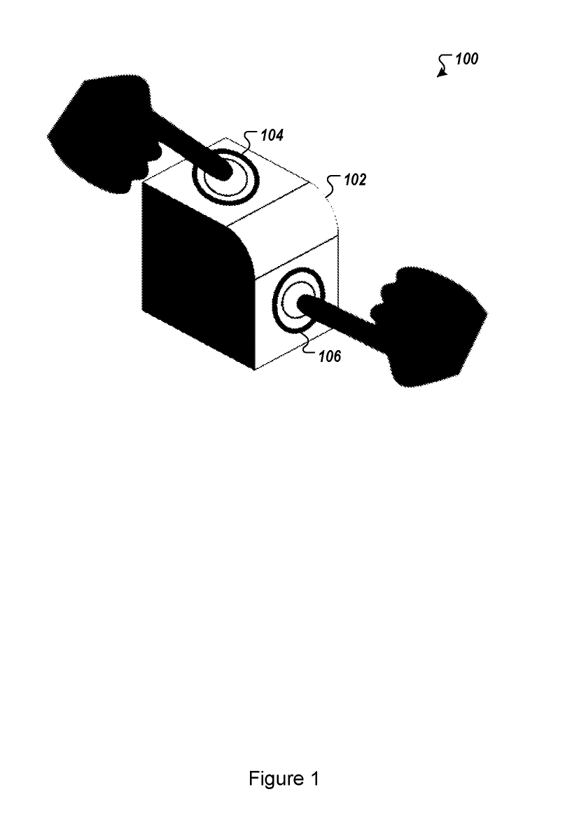

FIG. 1 illustrates an arrangement of an example multi-modal switch 100. The multi-modal switch 100 may include an external surface 102. The multi-modal switch 100 may include one or more contact interfaces 104, 106 (or touch points). A user contact interface may receive a touch input from a user. The user contact interface may provide one or more input force characteristics to a processor (not illustrated). The input force characteristics may include but are not limited to force magnitude, rise time, fall time, and/or hold time.

As illustrated, the multi-modal switch 100 includes two contact interfaces—a pair of differential-mode user contact interfaces 104, 106. The user contact interfaces 104, 106 may be arranged in any orientation, such as along a same plane or along different planes that may be disposed at any angle from each other. As illustrated, the user contact interfaces 104, 106 are orthogonally arranged such that both of the user contact interfaces 104, 106 are not arranged on a same horizontal plane (such as a plane defined by the external surface 102 or a contour of the external surface 102). This orthogonal orientation may be used to reduce a possibility of a user activating both of the user contact interfaces 104, 106 simultaneously.

The physical and electronic arrangement of the user contact interfaces 104, 106 may provide detection and measurement of an input force profile related to user touch parameters. In at least one embodiment, each of the user contact interfaces 104, 106 operates independently. For example, the user contact interface 104 may be associated with a first function, such as rolling down a vehicle window while the user contact interface 106 may correspond to a second function, such as locking a door in the vehicle. In at least one other embodiment, each of the user contact interfaces 104, 106 operate together. For example, the user contact interfaces 104, 106 may be simultaneously activated to perform a third function, such as opening/closing a rear hatch of the vehicle.

The dynamic force detection and measurement data provided by the user contact interfaces 104, 106 may be computationally processed, such as by a processing device (not illustrated), to provide interactive functional vehicle operation and control. The dynamic force detection and measurement provided by the user contact interfaces 104, 106 may be used in conjunction with semi-rigid, rigid or electrically conductive exterior surfaces 102 which would typically interfere with conventional resistive and capacitive based touch sensing techniques.

In at least one embodiment, the external surface 102 may be formed from a transparent, translucent, or selectively transparent material to enable surface illumination of embedded lighting elements. The embedded lighting elements may be used an indicators for various functions and operations. The indicators may include icons, image, designs, text, and the like. The embedded lighting elements may change color or state based on different functions and operations. For example, an embedded lighting element may display or illuminate a “locked” symbol and/or text when the vehicle doors are locked and an “unlocked” symbol when the vehicle doors are unlocked. Similarly, the embedded lighting element may display or illuminate a colored lock symbol with a first color when the vehicle doors are locked and may display or illuminate the colored lock symbol with a second color when the vehicle doors are unlocked. In at least one embodiment, an embedded lighting element may change color or state depending on a status of the vehicle. For example, the embedded lighting element may emit a first color when the vehicle is on and the engine is running. The embedded lighting element may emit a second color when the vehicle is on and the engine is not running.

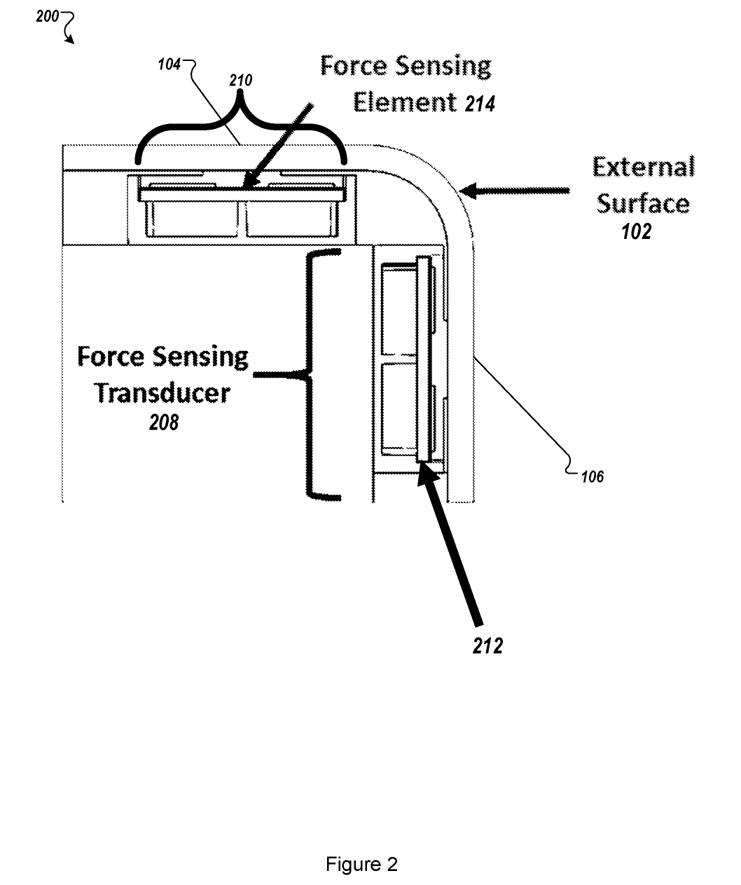

FIG. 2 illustrates a physical stack of a multi-modal switch 200. The multi-modal switch 200 may include the multi-modal switch 100 of FIG. 1. The multi-modal switch 200 may include one or more force sensing transducers that may be configured to enable force sensing detection of one or more touch points, such as the user contact interfaces 104, 106 of FIG. 1. As illustrated, the multi-modal switch 200 includes two force sensing transducers 208, 210 that are arranged orthogonally. The orthogonal arrangement of the force sensing transducers 208, 210 may reduce cross-talk between a pair of differential-mode touch points user contact interfaces 104, 106.

The multi-modal switch 200 may also include one or more force sensing elements. The force sensing transducers 208, 210, for example, may include one or more force sensing elements. As illustrated, the multi-modal switch 200 includes two force sensing elements 212, 214. The force sensing elements 212, 214 may be part of the force sensing transducers 208, 210, respectively. A force sensing element may be any type of sensor used to detect and sense force. The physical and electronic arrangement of the at least one force sensing element may provide detection and measurement of an input force profile related to user touch parameters, including but not limited to, discrete touch points, multi-touch points and/or gestures. Dynamic force detection and measurement may be compatible with substantially rigid and electrically conductive external surfaces 102. The dynamic force detection and measurement data is computationally processed to provide interactive functional control of any function or operations, such as vehicle entry, where some of the example functions include: door locking/latching, door unlocking/unlatching, trunk locking/latching, trunk unlocking/unlatching, climate control, cruise control, window actuation, stereo and video control, steering wheel control interface etc. Alternative applications include a security entry access panel, consumer gaming mouse interface, domestic appliance control panel, smart home applications, etc. In at least some embodiments, the force sensing element may include a capacitive touch sensor.

The multi-modal switch 200 may also include one or more haptic feedback elements. One or more haptic feedback elements may be integrated directly in contact with the external surface. This approach enables the user to experience haptic force feedback derived from force sensing. The haptic feedback element may include a haptic feedback driver and/or a haptic actuator. The haptic feedback driver may receive and process input received via the force sensing element and may translate the input into a haptic response. The haptic response may be any type of physical, optical (e.g., light-based), or audible, or a combination thereof. The haptic feedback driver may communicate the haptic response to the haptic actuator. The haptic actuator may perform the haptic response (e.g., provide a vibration, feedback motion, audible or visual response) via the multi-modal switch 200.

In some embodiments, the multi-modal switch 200 (and/or the one or more force sensing elements) includes a processor (not illustrated) that is configured to receive and interpret different inputs from an operator of the multi-modal switch 200. For example, the processor of the multi-modal switch 200 may be configured to receive and interpret different inputs to control different operations associated with the vehicle, such as door locking/latching, unlocking/unlatching, starting the vehicle ignition, opening a door or trunk, enabling or disabling a vehicle alarm system, opening or closing vehicle windows, climate control, cruise control, window actuation, stereo and video control, and the like.

The multi-modal switch 200 may be configured to provide a different haptic response for each different input. For example, the multi-modal switch 200 may provide a first vibration pattern to a user upon receiving an input to unlock the vehicle doors. The multi-modal switch 200 may provide a second vibration pattern upon receiving an input to lock the vehicle doors.

The multi-modal switch 200 may include one or more processors, a memory, and network communication capabilities. The one or more processors may be specialized processor that are configured to fit within a multi-modal switch 200. Further, the one or more processors may be configured to only execute instructions and/or operations related to various inputs received at the multi-modal switch 200, interpreting the received inputs into a vehicle function and for providing and/or driving a haptic output related to the vehicle function.

In some embodiments, the multi-modal switch 200 is in electrical communication (e.g., wired, wireless) with a processor of the vehicle to which the multi-modal switch 200 may be attached. In such instances, the multi-modal switch 200 may receive force input from one or more force sensing elements, communicate the force input to the vehicle processor, and receive an instruction to provide a particular haptic output.

In at least some embodiments, the multi-modal switch 200 includes a specialized processor that may receive force input from a force sensing element, communicate the force input to a vehicle processor, receive an instruction to provide a particular haptic output, and provide a signal or message to a haptic driver to provide the haptic output.

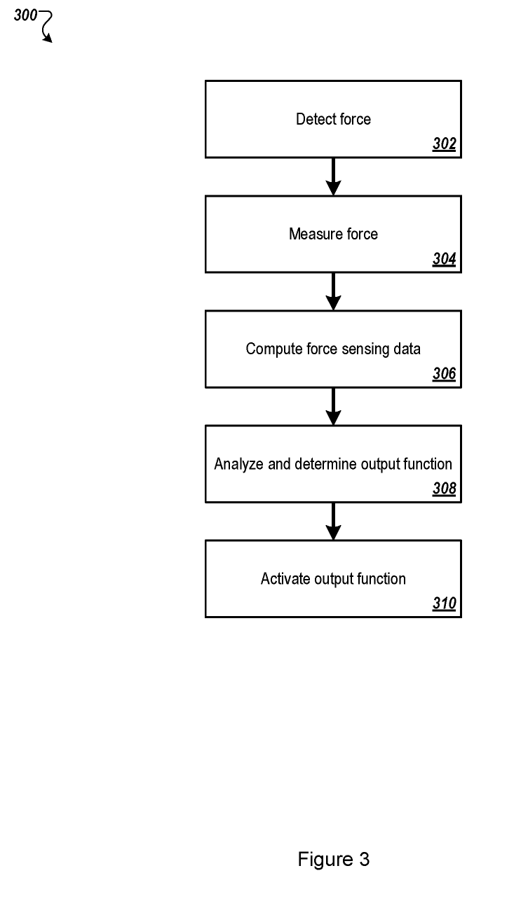

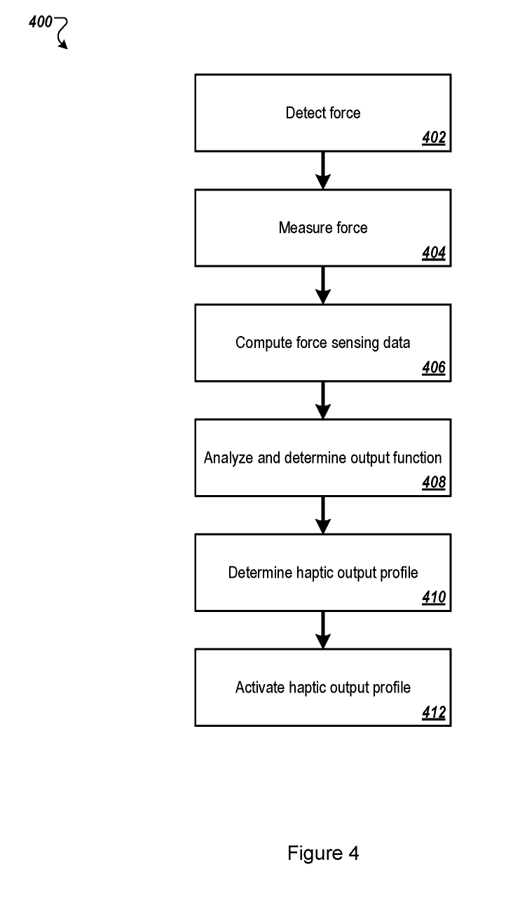

FIGS. 3-4 illustrate flow diagrams of example methods that may be used in conjunction with a multi-modal switch, such as any of the multi-modal switches further described in conjunction with FIGS. 1, 2, 5 and 6. The methods of FIGS. 3-4 may be performed by processing logic that may include hardware (circuitry, dedicated logic, etc.), software (such as is run on a general purpose computer system or a dedicated machine), or a combination of both, which processing logic may be included in a computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 3 illustrates an example method for dynamic force detection and measurement, computational processing of dynamic force detection and measurement and interactive functional control of a system, such as a vehicle, by operation of a multi-modal switch. Functions of the vehicle may include but are not limited to door locking/latching, door unlocking/unlatching, trunk locking/latching, trunk unlocking/unlatching, climate control, cruise control, window actuation, stereo and video control, etc. Computational processing of dynamic force detection and measurement data from one or more force sensing elements may be used to determine an output function.

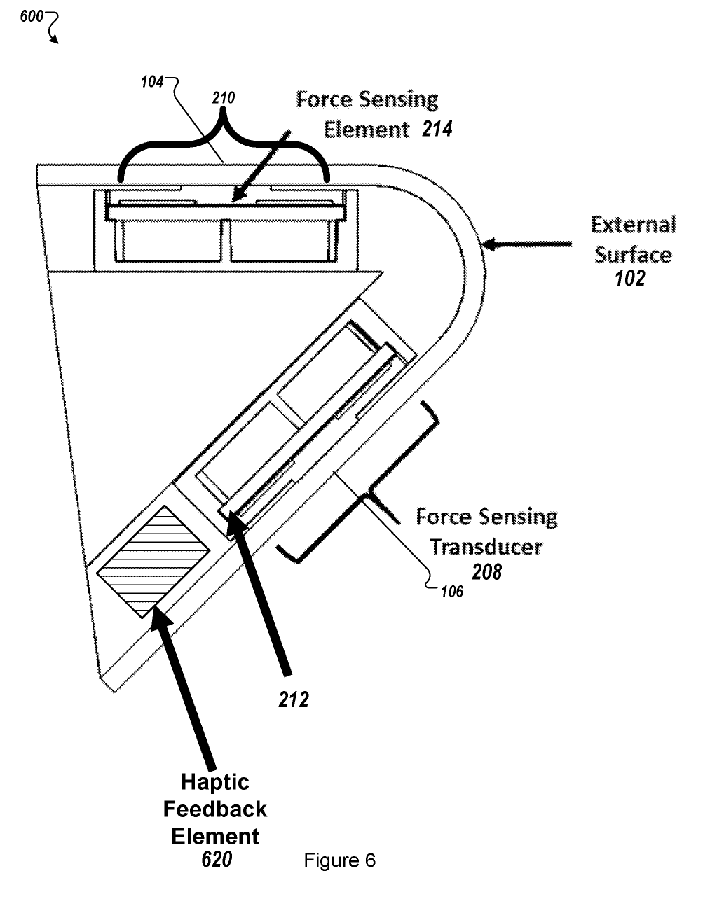

The method of FIG. 3 may begin at block 302, where the processing logic may detect a force via the multi-modal switch. The force may be detected using a force sensing element, as described in conjunction with FIGS. 2 and 6.

At block 304, the processing logic may measure the force detected at block 302. In some embodiments, the processing logic may detect a magnitude and a direction of the force. At block 306, the processing logic may compute force sensing data to determine whether the detected force on the multi-modal switch corresponds to an available function. For example, the detected force on the multi-modal switch may be a swipe from left to right, which may correspond to unlocking the doors of a vehicle. At block 306, the processing logic may identify this type of relationship between the detected force and a valid and available vehicle function.

At block 308, the processing logic may analyze the force sensing data and may determine an output function. For example, the processing logic may determine that the detected force corresponds to particular output, such as a vehicle function.

At block 310, the processing logic may activate the output function. In at least some embodiments, the output function is a vehicle function and the processing logic may perform the vehicle function or may cause the vehicle function to be performed, via the vehicle and/or via the multi-modal switch.

FIG. 4 illustrates a flow diagram of another example method of dynamic force detection and measurement, computational processing of dynamic force detection and measurement, and interactive functional control of an object or system by operation of a multi-modal switch. Functions of the object or system may include but are not limited to door locking/latching or unlocking/unlatching, and interactive control of haptic feedback profile for haptic feedback elements.

The method of FIG. 4 may begin at block 402 where the processing logic may detect a force via a multi-modal switch. The force may be detected using one or more force sensing elements, as described in conjunction with FIGS. 2 and 6.

At block 404, the processing logic may measure the force detected at block 402. In some embodiments, the processing logic may detect force amplitude. At block 404, the processing logic may compute force sensing data parameters including but not limited to rise time, fall time and pulse width corresponding to the input force profile.

At block 408, the processing logic may analyze the force sensing data and may determine an output function. For example, the processing logic may determine that the detected force corresponds to an available vehicle function.

At block 410, the processing logic may determine a haptic output profile that corresponds with the function determined at block 408. The function may correspond to a particular haptic output profile. For example, a vehicle function of starting an ignition may correspond to a particular haptic output profile that indicates to a user who is near the multi-modal switch, that the multi-modal switch received the input force that corresponds to starting the ignition of the vehicle. At block 412, the processing logic may active the haptic output profile, via the multi-modal switch or via another component attached to the multi-modal switch.

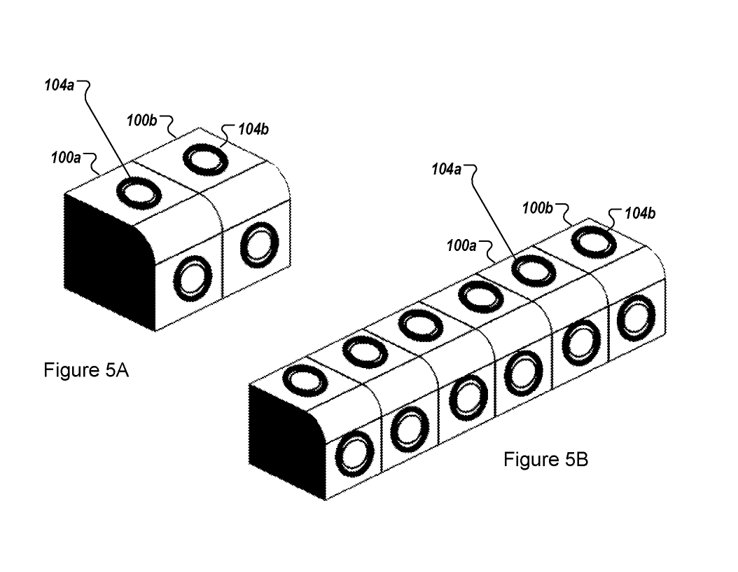

FIGS. 5A-5B illustrates example embodiments where two or more pairs of differential-mode force sensing elements may be implemented. A physical arrangement of the two or more pairs of differential-mode force sensing elements may enable common-mode activation of force sensing elements located on a same horizontal plane. For example, FIG. 5A illustrates a pair of multi-modal switches 100a, 100b, where each of the multi-modal switches 100a, 100b has at least one contact interfaces 104a, 104b, respectively, which may drive corresponding force sending elements. A vehicle function may be activated in response to a user contacting both of the contact interfaces 104a, 104b. The common-mode activation may include independent touch points and gestures that may be unique to the common-mode activation of a particular function. Each touch point 104 may provide input force characteristics including but not limited to force magnitude, rise time, fall time and hold time. Any number of multi-modal switches 100 may be used for a common-mode activation. As illustrated in FIG. 5B, six multi-modal switches 100 may be arranged in a switch bank. Some or all of the multi-modal switches 100 of FIG. 5B may be used for common-mode activation of a particular function.

FIG. 6 illustrates another embodiment of a physical stack of a multi-modal switch 600. The multi-modal switch 600 may be the multi-modal switch 100 of FIG. 1 and may have similar features as the multi-modal switch 200 of FIG. 2. The multi-modal switch 600 may include one or more force sensing transducers that may be configured to enable force sensing detection of one or more touch points, such as the user contact interfaces 104, 106 of FIG. 1. As illustrated, the multi-modal switch 600 includes two force sensing transducers 208, 210.

The force sensing transducers 208, 210 may be arranged at any angle with respect to each other. In at least one embodiment, the positions of the force sensing transducers 208, 210 may be static or movable. A movable configuration may be useful for providing mechanical tactile feedback. In at least one embodiment, the external surface 102 may be made using a flexible material to accommodate a change in position of the force sensing transducers 208, 210.

The multi-modal switch 600 may also include one or more force sensing elements. The force sensing transducer, for example, may include one or more force sensing elements. As illustrated, the multi-modal switch 200 includes two force sensing elements 212, 214. The force sensing elements 212, 214 may be part of the force sensing transducers 208, 210, respectively.

The multi-modal switch 600 may also include one or more haptic feedback elements 620. One or more haptic feedback elements 620 may be integrated directly in contact with the external surface 102. This approach enables the user to experience haptic force feedback derived from force sensing. The haptic feedback element 620 may include a haptic feedback driver and/or a haptic actuator. The haptic feedback driver may receive and process input received via the force sensing element and may translate the input into a haptic response. The haptic response may be any type of physical, optical (e.g., light-based), or audible, or a combination thereof. The haptic feedback driver may communicate the haptic response to the haptic actuator. The haptic actuator may perform the haptic response (e.g., provide a vibration, feedback motion, audible or visual response) via the multi-modal switch 600.

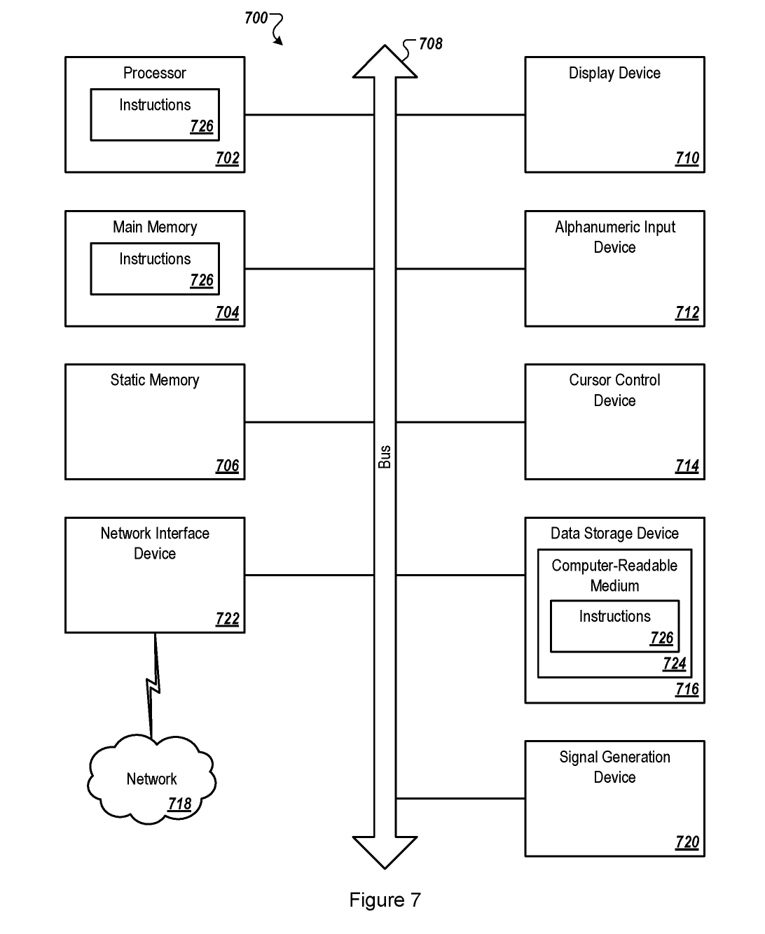

FIG. 7 illustrates a block diagram of an example computer system 700 related to a multi-modal switch, according to at least one embodiment of the present disclosure. The multi-modal switch of FIG. 2 may be implemented as a computing system such as the example computer system 700. The computer system 700 may be configured to implement one or more operations of the present disclosure.

The computer system 700 executes one or more sets of instructions 726 that cause the machine to perform any one or more of the methods discussed herein. The machine may operate in the capacity of a server or a client machine in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions 726 to perform any one or more of the methods discussed herein.

The computer system 700 includes a processor 702, a main memory 704 (e.g., read-only memory (ROM), flash memory, dynamic random access memory (DRAM) such as synchronous DRAM (SDRAM) or Rambus DRAM (RDRAM), etc.), a static memory 707 (e.g., flash memory, static random access memory (SRAM), etc.), and a data storage device 716, which communicate with each other via a bus 708.

The processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 may also be one or more special-purpose processing devices such as an application specific integrated circuit (ASIC), a field programmable gate array (FPGA), a digital signal processor (DSP), network processor, or the like. The processor 702 is configured to execute instructions for performing the operations and steps discussed herein.

The computer system 700 may further include a network interface device 722 that provides communication with other machines over a network 718, such as a local area network (LAN), an intranet, an extranet, or the Internet. The network interface device 722 may include any number of physical or logical interfaces. The network interface device 722 may include any device, system, component, or collection of components configured to allow or facilitate communication between network components in a network. For example, the network interface device 722 may include, without limitation, a modem, a network card (wireless or wired), an infrared communication device, an optical communication device, a wireless communication device (such as an antenna), and/or chipset (such as a Bluetooth device, an 802.7 device (e.g. Metropolitan Area Network (MAN)), a WiFi device, a WiMax device, cellular communication facilities, etc.), and/or the like. The network interface device 722 may permit data to be exchanged with a network (such as a cellular network, a WiFi network, a MAN, an optical network, etc., to name a few examples) and/or any other devices described in the present disclosure, including remote devices. In at least one embodiment, the network interface device 722 may be logical distinctions on a single physical component, for example, multiple communication streams across a single physical cable or optical signal.

The computer system 700 also may include a display device 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 716 may include a computer-readable storage medium 724 on which is stored the sets of instructions 726 embodying any one or more of the methods or functions described herein. The sets of instructions 726 may also reside, completely or at least partially, within the main memory 704 and/or within the processor 702 during execution thereof by the computer system 700, the main memory 704 and the processor 702 also constituting computer-readable storage media. The sets of instructions 726 may further be transmitted or received over the network 718 via the network interface device 722.

While the example of the computer-readable storage medium 724 is shown as a single medium, the term “computer-readable storage medium” may include a single medium or multiple media (e.g., a centralized or distributed database, and/or associated caches and servers) that store the sets of instructions 726. The term “computer-readable storage medium” may include any medium that is capable of storing, encoding or carrying a set of instructions for execution by the machine and that cause the machine to perform any one or more of the methods of the present disclosure. The term “computer-readable storage medium” may include, but not be limited to, solid-state memories, optical media, and magnetic media.

Modifications, additions, or omissions may be made to the computer system 700 without departing from the scope of the present disclosure. For example, in at least one embodiment, the computer system 700 may include any number of other components that may not be explicitly illustrated or described.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In at least one embodiment, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations may be made hereto without departing from the spirit and scope of the present disclosure.

What is claimed is:

1. A system, comprising:
a first force sensing transducer being configured to enable force sensing detection of a first force input on a first contact interface;
a memory; and
a processor operatively coupled to the memory and the first force sensing transducer, the processor being configured to perform operations comprising:
detect the first force input on the first contact interface via the first force sensing transducer;
measure at least one of a magnitude or a direction of the first force input detected by the first force sensing transducer;
compute a force sensing data parameter based on the measured at least one of the magnitude or the direction of the first force input;
determine an output function based on the force sensing data parameter; and
cause an activation of the output function.

2. The system of claim 1 further comprising a first contact interface configured to receive force input from a user, the first contact interface being associated with the first force sensing transducer interface.

3. The system of claim 1 further comprising a second force sensing transducer being configured to enable force sensing detection of a second force input on a second contact interface, wherein the processor is further configured to perform operations comprising:
detect the second force input on the second contact interface via the second force sensing transducer; and
measure at least one of a magnitude or a direction of the second force input detected by the second force sensing transducer,
wherein the force sensing data parameter is computed based on (a) the measured at least one of the magnitude or the direction of the first force input, and (b) the measured at least one of the magnitude or the direction of the second force input.

4. The system of claim 3, wherein the first force sensing transducer and the second force sensing transducer are arranged on different, non-parallel planes.

5. The system of claim 1, wherein the first force input includes at least one of: a rise time, a fall time, or hold time.

6. The system of claim 1, wherein when computing the force sensing data parameter, the processor is configured to determine that the first force input included at least one of a discrete touch point, one or more multi-touch points, or one or more gestures.

7. The system of claim 1, wherein the output function includes an operation of a system.

8. The system of claim 1, wherein when causing the activation of the output function, the processor is configured to send, via a network, at least one of the force sensing data parameter or the output function to a second processor, wherein the second processor is configured to cause the activation of the output function.

9. The system of claim 1 further comprising an external surface coupled to the first contact interface.

10. The system of claim 9 further comprising at least one embedded lighting element, wherein the external surface is formed from a transparent, translucent, or selectively transparent material to enable surface illumination of the at least one embedded lighting element.

11. The system of claim 1 further comprising one or more haptic feedback elements located proximate to the first contact interface, wherein the output function includes at least one haptic emission to be generated by the one or more haptic feedback elements, wherein causing the activation of the output function comprises causing the one or more haptic feedback elements to generate the at least one haptic emission.

12. A method, comprising:
detecting a force input on a surface of a multi-modal switch by one or more force sensing elements;
measuring at least one of a magnitude or a direction of the force input detected by the one or more force sensing elements;
computing a force sensing data parameter based on the measured at least one of the magnitude or the direction of the force input;
determining an output function based on the force sensing data parameter; and
causing an activation of the output function.

13. The method of claim 12, wherein detecting the force input on the surface of the multi-modal switch by the one or more force sensing elements comprises:
detecting a first force input by a first force sensing element; and
detecting a second force input by a second force sensing element.

14. The method of claim 13, wherein measuring at least one of the magnitude or the direction of the force input detected by the one or more force sensing elements comprises:
measuring at least one of a first magnitude or a first direction of the first force input detected by the first force sensing element; and
measuring at least one of a second magnitude or a second direction of the second force input detected by the second force sensing element.

15. The method of claim 13, wherein the force sensing data parameter is computed based on the first force input and the second force input.

16. The system of claim 1, wherein the force input includes at least one of: a rise time, a fall time, or hold time.

17. A non-transitory computer-readable medium having encoded therein programming code executable by a processor to perform operations comprising:
detect a force input on a surface of a multi-modal switch by one or more force sensing elements;
measure at least one of a magnitude or a direction of the force input detected by the one or more force sensing elements;
compute a force sensing data parameter based on the measured at least one of the magnitude or the direction of the force input;
determine an output function based on the force sensing data parameter; and
cause an activation of the output function.

18. The non-transitory computer-readable medium of claim 17, wherein when causing the processor to detect the force input on the surface of the multi-modal switch by the one or more force sensing elements, the programming code causes the processor to:
detect a first force input by a first force sensing element; and
detect a second force input by a second force sensing element.

19. The non-transitory computer-readable medium of claim 18, wherein when causing the processor to measure at least one of the magnitude or the direction of the force input detected by the one or more force sensing elements, the programming code causes the processor to:
measure at least one of a first magnitude or a first direction of the first force input detected by the first force sensing element; and
measure at least one of a second magnitude or a second direction of the second force input detected by the second force sensing element.

20. The non-transitory computer-readable medium of claim 18, wherein the force sensing data parameter is computed based on the first force input and the second force input.
